(19) United States
(12) Patent Application Publication
(10) Pub. No.: US 2015/0287342 A1
(43) Pub. Date: Oct. 8, 2015

(54) DATABASE-DRIVEN COMPUTER-IMPLEMENTED METHODS AND SPECIFICALLY PROGRAMMED COMPUTER SYSTEMS FOR ANALYSIS AND/OR FEEDBACK TO ACHIEVE/CONTROL RESPONSIBLE GAMING

(71) Applicants: Christos Dimitriadis, Athens (GR); Polyxeni Ziouvelou, Peania (GR); Ioannis Loukeris, Peania (GR)

(72) Inventors: Christos Dimitriadis, Athens (GR); Polyxeni Ziouvelou, Peania (GR); Ioannis Loukeris, Peania (GR)

(21) Appl. No.: 14/679,826

(22) Filed: Apr. 6, 2015

Related U.S. Application Data
(60) Provisional application No. 61/975,503, filed on Apr. 4, 2014.

(51) Int. Cl. G09B 19/22; G09B 19/00

(52) U.S. Cl. CPC G09B 19/22; G09B 19/00

(57) ABSTRACT

In some embodiments, the instant invention provides for a computer-implemented method, including: concurrently receiving, via a computer network, by a specifically programmed game operating system, from each user of the plurality of users, utilizing a specialized graphical user interface generated by user risk evaluation software distributed by the specifically programmed game operating system to a computer device of such user, responses to at least one social responsibility self-awareness test; concurrently analyzing the responses of such user to the at least one social responsibility self-awareness test; concurrently identifying at least one game that such user is playing or is to be played; concurrently analyzing, the at least one game to determine a personalized addictiveness value of the at least one game for such user; concurrently generating at least one personalized game addictiveness alert for such user; concurrently delivering the at least one personalized game addictiveness alert.

### RELATED APPLICATION

This application claims the priority of U.S. provisional application U.S. Patent Appln. No. 61/975,503; filed Apr. 4, 2014; entitled “COMPUTER-IMPLEMENTED METHODS AND SPECIFICALLY PROGRAMMED SYSTEMS FOR ANALYSIS AND/OR FEEDBACK TO ACHIEVE/CONTROL RESPONSIBLE GAMING,” which is incorporated herein by reference in its entirety for all purposes.

### TECHNICAL FIELD

In some embodiments, the instant invention is related to specifically programmed game database driven computer system and methods to evaluate the likelihood of a game being addictive for a particular user and to deliver a real-time alert to the user.

### BACKGROUND

Problem gambling (or ludomania, but usually referred to as gambling addiction) is an urge to continuously gamble despite harmful negative consequences and/or a desire to stop. Problem gambling is often defined by whether harm is experienced by the gambler or others, rather than by the gambler's behavior.

### SUMMARY OF INVENTION

In some embodiments, the instant invention provides for a computer-implemented method, including: concurrently receiving, via a computer network, by a specifically programmed game database driven computer system, from each user of the plurality of users, utilizing a specialized graphical user interface generated by user risk evaluation software distributed by the specifically programmed game operating system to a computer device of such user, responses to at least one social responsibility self-awareness test; where the plurality of users is at least a thousand of users; where the at least one social responsibility self-awareness test includes a plurality of questions related to psychiatric characteristics of a gambling addiction; concurrently analyzing, by the specifically programmed game operating system, for each user of the plurality of users, the responses of such user to the at least one social responsibility self-awareness test to determine a gambling self-awareness score of such user, based, at least in part, on a problem gambling severity index (PGSI); concurrently identifying, by the specifically programmed game operating system, for each user of the plurality of users, at least one game that such user is playing or is to be played; where the at least one game is characterized by at least one structural characteristic of a plurality of structural characteristics and at least one situational characteristic of a plurality of situational characteristics; where the plurality of the structural characteristics is selected from the group consisting of: event frequency, jackpot, continuity of playing, multiple stake opportunities, variable stake amount, near wins, prizeback percentage, interval of payback, social element, game speed, and any combination thereof; concurrently analyzing, by the specifically programmed game operating system, for each user of the plurality of users, the at least one game to determine a personalized addictiveness value of the at least one game for such user, based, at least in part, on: i) the gambling self-awareness score of such user, ii) the at least one structural characteristic of the at least one game, and iii) the at least one situational characteristic of the at least one game; concurrently generating, by the specifically programmed game operating system, for each user of the plurality of users, at least one personalized game addictiveness alert for such user, based on the personalized addictiveness value of the at least one game for such user; concurrently delivering, via the computer network, by the specifically programmed game operating system, to each user of the plurality of users, utilizing the specialized graphical user interface generated by the user risk evaluation software distributed by the specifically programmed game operating system to the computer device of such user, the at least one personalized game addictiveness alert.

In some embodiments, the personalized game addictiveness alert is configured to allow each user of the plurality of users to set at least one risk averse parameter in the at least one game, where the at least one risk averse parameter is selected from the group consisting of: (a) user-specified spend limits, (b) user-specified loss limits, (c) user-specified deposit limits, (d) user-specified time limits, (e) user-initiated self-exclusion, or (f) any combination thereof. In some embodiments, the method further includes incorporating, by the specifically programmed game operating system, the at least one risk averse parameter into the at least one game. In some embodiments, situational characteristics include: game personalization, aural stimulation and visual stimulation, free games, or any combination thereof. In some embodiments, the situational characteristics of an offline game includes: physical accessibility, payment options, record setting, or any combination thereof. In some embodiments, the situational characteristics of an online game includes: virtual accessibility, payment options, record setting/beating the game, or any combination thereof.

In some embodiments, the instant invention provides for a computer-implemented system, including: at least one specialized server specifically programmed with game evaluation software stored on a non-transient computer readable medium, where the specialized server, upon execution of the specifically programmed with game evaluation software is configured to at least perform: concurrently receive, via a computer network, from each user of the plurality of users, utilizing a specialized graphical user interface generated by user risk evaluation software distributed by the specifically programmed game operating system to a computer device of such user, responses to at least one social responsibility self-awareness test; where the plurality of users is at least a thousand of users; where the at least one social responsibility self-awareness test includes a plurality of questions related to psychiatric characteristics of a gambling addiction; concurrently analyze, for each user of the plurality of users, the responses of such user to the at least one social responsibility self-awareness test to determine a gambling self-awareness score of such user, based, at least in part, on a problem gambling severity index (PGSI); concurrently identify, for each user of the plurality of users, at least one game that such user is playing or is to be played; where the at least one game is characterized by at least one structural characteristic of a plurality of structural characteristics and at least one situational characteristic of a plurality of situational characteristics; where the plurality of the structural characteristics is selected from the group consisting of: event frequency, jackpot, continuity of playing, stake opportunities, variable stake amount, near wins, prizeback percentage, interval of payback, social element, game speed, and any combination thereof; concurrently analyze, for each user of the plurality of users, the at least one game to determine a personalized addictiveness value of the at least one game for such user, based, at least in part, on: i) the gambling self-awareness score of such user, ii) the at least one structural characteristic of the at least one game, and iii) the at least one situational characteristic of the at least one game; concurrently generate, for each user of the plurality of users, at least one personalized game addictiveness alert for such user, based on the personalized addictiveness value of the at least one game for such user; concurrently deliver, via the computer network, to each user of the plurality of users, utilizing the specialized graphical user interface generated by the user risk evaluation software distributed by the specifically programmed game operating system to the computer device of such user, the at least one personalized game addictiveness alert.

In some embodiments, the personalized game addictiveness alert is configured to allow each user of the plurality of users to set at least one risk averse parameter in the at least one game, where the at least one risk averse parameter is selected from the group consisting of: (a) user-specified spend limits, (b) user-specified loss limits, (c) user-specified deposit limits, (d) user-specified time limits, (e) user-initiated self-exclusion, or (f) any combination thereof. In some embodiments, the system further includes incorporating, by the specifically programmed game operating system, the at least one risk averse parameter into the at least one game. In some embodiments, the situational characteristics include: game personalization, aural stimulation and visual stimulation, free games, or any combination thereof. In some embodiments, the situational characteristics of an offline game includes: physical accessibility, payment options, record setting, or any combination thereof. In some embodiments, the situational characteristics of an online game includes: virtual accessibility, payment options, record setting, or any combination thereof.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 illustrates some embodiments of the specifically programmed game database driven computer method of the present invention, showing communication with a network, client devices, and network servers.

FIG. 2 illustrates an embodiment of the network architecture of specifically programmed game database driven computer method of the present invention.

FIGS. 3A and 3B illustrate an embodiment of the specifically programmed game database driven computer method of the present invention. FIGS. 3A and 3B present an overview of the invention, its categories and subcategories as well as the characteristics.

FIG. 4 illustrates an embodiment of the specifically programmed game database driven computer method of the present invention, showing an analysis of Game Risk Assessment Instruments.

FIGS. 5-8 are illustrative diagrams related to some embodiments of the specifically programmed game database driven computer systems of the present invention. The specific disclosure of American Psychiatric Association's Diagnostic and Statistical Manual of Mental Disorder (Fifth Edition, 2013) is hereby incorporated by reference herein in its entirety.

FIG. 9 is an illustrative diagram related to some embodiments of specifically programmed game database driven computer methods of the present invention.

FIG. 10 is an illustrative diagram related to some embodiments of the specifically programmed game database driven computer method of the present invention.

FIGS. 11-13 are illustrative diagrams related to some embodiments of the specifically programmed game database driven computer system of the present invention.

FIG. 14 is an illustrative diagram related to some embodiments of the specifically programmed game database driven computer system of the present invention.

FIG. 15 is an illustrative diagram related to some embodiments of the specifically programmed game database driven computer method of the present invention.

FIG. 16 is an illustrative diagram related to some embodiments of the specifically programmed game database driven computer method of the present invention.

FIGS. 17 and 18 illustrate some further aspects of some embodiments of the specifically programmed game database driven computer method of the present invention.

FIGS. 19 and 20 illustrate some further aspects of some embodiments of the specifically programmed game database driven computer method of the present invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DESCRIPTION OF EXEMPLARY EMBODIMENTS

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The specific disclosure of “Rating the suitability of responsible gambling features for specific game types: a resource for optimizing responsible gambling strategy” (Wood, R. T. A. et al., International Journal of Mental Health and Addiction; 2014, 12(1):94-112) is hereby incorporated by reference herein in its entirety.

Some embodiments of the specifically programmed game database driven computer system of the present invention are directed to a holistic and innovative “Game Evaluation (GE) Tool,” which provides parameters to determine whether an individual is likely to become addicted to a game featuring gambling.

In some embodiments of the specifically programmed game database driven computer system of the present invention, the game-evaluation module comprises (1) a front end/user interface that is implemented on a webserver; (2) a decision making mechanism that is based on a decision tree that allows game designers to evaluate whether a proposed game-design has high risk of being addictive or not; and (3) a repository of game evaluation results and past knowledge residing in a database.

In another embodiment of the specifically programmed game database driven computer system of the present invention, the web server can be accessible from a desktop computer, mobile computer/device, locally and/or over the Internet.

In another embodiment of the specifically programmed game database driven computer system of the present invention, the decision tree is implemented on an application service that utilizes a knowledgebase from psychiatric studies in gambling and other addictive behaviors, focusing on aspects of games such as intrinsic game characteristics (speed, game cycle, repetitive behavior, etc.) as well as external characteristics (such as visual aspects of the game, audio properties such as the spinning of the roulette wheel, etc.) that may contribute to the addictive properties of the game.

In some embodiments of the specifically programmed game database driven computer system of the present invention, addiction detection categories in the academic and empirical literature enabled the identification of at least three parameters, specifically: (a) game mode, the extent to which a game is played offline or online; (b) game implementation plan, the specific context of implementation (i.e., country, region, etc.), and (c) game characteristics, the addictive characteristics of games that cam be classified into at least three categories: (1) structural characteristics: features inherent within the game itself that may facilitate initiation, development and maintenance of game playing over time, (2) situational characteristics: game features (primarily features of the environment) that are typically those that get people to gamble in the first place (“situational characteristics” is defined, for online games, as the characteristics that do not directly impact the actual games but rather the “context” of the online game), and (3) responsible gaming characteristics: entail features that may impact the players gaming pattern (i.e., self-imposed limits either time or money limits, etc.)

In some embodiments of the specifically programmed game database driven computer system of the present invention, a “Phase 1: Game Mode” comprises a question:

Question: The game is primarily played:

A. Offline

B. Online

In some embodiments of the specifically programmed game database driven computer system of the present invention, a “Phase 2: Gaming Implementation Context” comprises a question:

Question: The game will be implemented in which context country, region etc.

In some embodiments of the specifically programmed game database driven computer method of the present invention, a “Phase 3: Game Characteristics” comprises an examination of diverse characteristics based on the answer provided in Phase 1.

In another embodiment of the specifically programmed game database driven computer system of the present invention, the “online” game mode, situational characteristics consider only the features of the online/digital environment.

GE Tool (Present Invention) Measurement

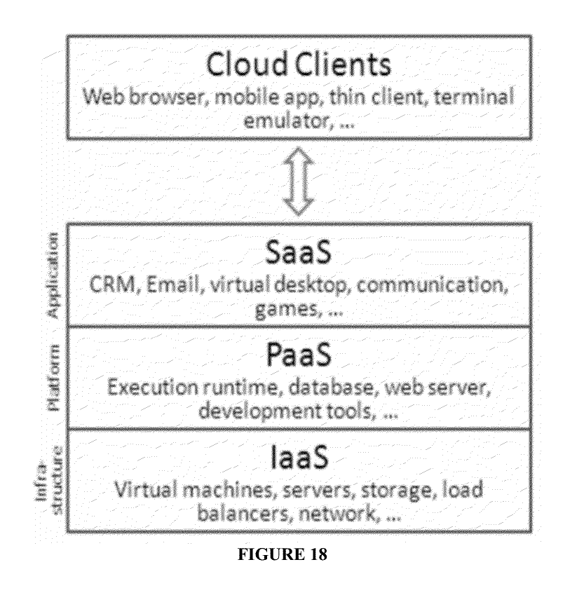

In some embodiments of the specifically programmed game database driven computer system of the present invention, the scales of the GE Tool (present invention) are symmetric and are standardized between 0-10, where 0 (of no importance) and 10 (of very great importance). In another embodiment, the GE Tool considers 3 key categories dimensions (parameters) to examine the risk potential of different gambling products, which is illustrated in FIG. 19 as a GE Tool Variable Overview.

Scoring System

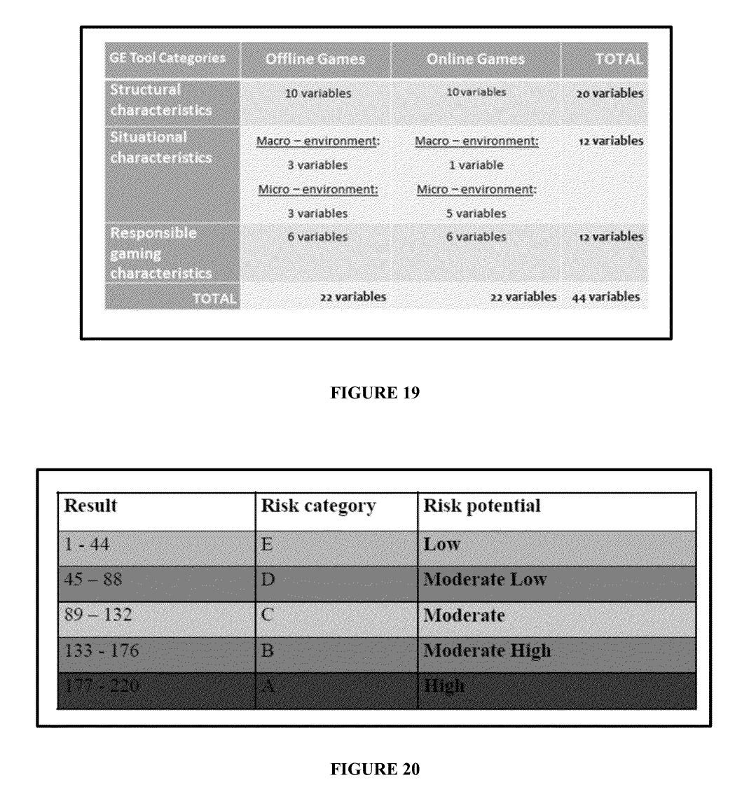

In some embodiments of the specifically programmed game database driven computer system of the present invention, a scoring system of the present invention (GE Tool) entails that the total points, of a game implemented in a specific context, are classified into five categories of equal amplitude, the results can be seen to map five categories of risk, and is shown in FIG. 20.

Structural Characteristics

In some embodiments of the specifically programmed game database driven computer system of the present invention, an event frequency is measured. In some embodiments, the event frequency is measured as a unit of time between stake, gambling result, and next stake opportunity, as shown in Table 1:

TABLE 1
Scale

| | >24 | >1 | >10 | >3 | >1 | >15 | >5 | |
|---|---|---|---|---|---|---|---|---|
| >6 | hrs ≦ | hr ≦ | min ≦ | min ≦ | min ≦ | sec ≦ | sec ≦ | ≦5 |
| days | 6 days | 24 hrs | 1 hr | 10 min | 3 min | 1 min | 15 sec | sec |
| 0 | 1.25 | 2.5 | 3.75 | 5 | 6.25 | 7.5 | 8.75 | 10 |

In some embodiments of the specifically programmed game database driven computer system of the present invention, a jackpot may be awarded, as shown in Table 2. In some embodiments, a jackpot is an extraordinary top prize typically in the form of a large amount of money formed by the accumulation of previous bets. In some embodiments, a jackpot refers the maximum possible, not just the maximum awarded so far.

TABLE 2
Scale

| | ≧0 | ≧100 | ≧1.000 | | ≧50.000 | | |
|---|---|---|---|---|---|---|---|
| | $ < | $ < | $ < | ≧10.000 | $ < | ≧100.000 | ≧1 |
| non | 100 | 1.000 | 10.000 | $ < | 100.000 | $ < | Mio. |
| existent | $ | $ | $ | 50.000 $ | $ | 1 Mio. $ | $ |
| 0 | 1.25 | 2.5 | 4 | 6 | 7.5 | 8.75 | 10 |

In some embodiments of the specifically programmed game database driven computer system of the present invention, continuity of playing is measured, as shown in Table 3. In another embodiment, continuity of playing is measured as the period of time during which it is possible to gamble without interruption. In another embodiment, for games that have one event per day or per larger amount of time, the correct answer here is “Not Applicable”.

TABLE 3
Scale

| | ≦5 min | >5 min | >30 min | >1 hour | |
|---|---|---|---|---|---|
| | of | ≦30 min | ≦1 hour | ≦3 hrs | >3 hrs |
| Not | continuous | of continuous | of continuous | of continuous | of continuous |
| Applicable | gambling | gambling | gambling | gambling | gambling |
| 0 | 0 | 2.5 | 5 | 7.5 | 10 |

In some embodiments of the specifically programmed game database driven computer system of the present invention, multiple playing-/stake opportunities are available to a user. In some embodiments, the multiple playing-/stake opportunities comprise at least one opportunity to play several stakes at the same time (e.g. betting on several roulette numbers) or to take part in several gambling opportunities at the same time (e.g. playing different slot-machines at the same time or playing different online-poker-tables on different screens at the same time).

In some embodiments of the specifically programmed game database driven computer system of the present invention, multiple playing is considered in the context of same kind of game but different gaming instance at the same time participation, not in different or subsequent games (i.e. not playing blackjack and poker at the same time or betting on several sequential sports events), as shown in Table 4. Therefore, land-based games with coupon may have multi-stake opportunities but not multi-play as there is one single and global gaming instance.

TABLE 4
Scale

| no multiple playing | multiple playing | multiple playing |
|---|---|---|
| opportunity | opportunities | opportunities |
| and no multiple stake | or multiple stake | and multiple stake |
| opportunity | opportunities | opportunities |
| 0 | 5 | 10 |

In some embodiments of the specifically programmed game database driven computer system of the present invention, a variable stake amount is available to a user, as shown in Table 5. In some embodiments, the variable stake amount is the extent to which gamblers can choose or modify their stake amounts while playing. In some embodiments, a lotto game, for example, with specified and fixed amount per column played (regardless of multiplier availability) is considered fixed stake amount. In another embodiment, a roulette that permits arbitrary bets on its numbers is considered variable stake.

TABLE 5
Scale

| no variable (=fixed) | variable stake, | variable stake, |
|---|---|---|
| stake amount | limited stake amount | unlimited stake amount |
| 0 | 5 | 10 |

In some embodiments of the specifically programmed game database driven computer system of the present invention, near wins are measured. In another embodiment, a near win is when a gambler supposes that he/she almost won the game round (to miss the profit narrowly, for one different number or digit for example; a near win).

In some embodiments of the specifically programmed game database driven computer system of the present invention, for example, when a numeric game returns 10 numbers as a result that are all but one or two the choices of the player he considers that he was very close to winning, as shown in Table 6. In some embodiments, the same applies when there are other kinds of patterns such as when all or the majority of numbers returned differ by one compared to the players choices, etc.

TABLE 6
Scale

| | | intentionally created by |
|---|---|---|
| | un-intentionally | supplier/producer, |
| | created, occurring by | occurring more frequently |
| non-existent | chance | than random |
| 0 | 5 | 10 |

In some embodiments of the specifically programmed game database driven computer system of the present invention, a prizeback percentage/payout ratio is calculated, as shown in Table 7. In some embodiments, a prizeback percentage/payout ratio is the average percentage of the stake that is played back in winnings

TABLE 7
Scale

| 50% or | 51-60% or | 61-70% or | 71-80% or | |
|---|---|---|---|---|
| below | variable ods | variable ods | variable ods | 81% or more |
| 0 | 2.5 | 5 | 7.5 | 10 |

In some embodiments of the specifically programmed game database driven computer system of the present invention, an interval of payback is measured, as shown in Table 8. In some embodiments, an interval of payback is a period of time between a gambling result and an actual receipt of payment. In some embodiments, the interval of payback is the average time the player can get his winnings In some embodiments, for example, in some lotteries the process may take more than a week, while on a lotto type game within two or three days the winnings have been distributed. In another embodiment, the interval of payback should take into consideration the averages, not extreme cases, and is related to the time needed before the player can gamble his winnings

TABLE 8
Scale

| | >24 | >1 | >10 | >3 | >1 | >15 | >5 | |
|---|---|---|---|---|---|---|---|---|
| >6 | hrs ≦ | hr ≦ | min ≦ | min ≦ | min ≦ | sec ≦ | sec ≦ | ≦5 |
| days | 6 days | 24 hrs | 1 hr | 10 min | 3 min | 1 min | 15 sec | sec |
| 0 | 1.25 | 2.5 | 3.75 | 5 | 6.25 | 7.5 | 8.75 | 10 |

In some embodiments of the specifically programmed game database driven computer system of the present invention, a social element/creation of relationships with others is measured. In some embodiments, a social element/creation of relationships with others is the extent to which a game facilitates or requires the creation of relationships with others. In some embodiments, the following options are available:

Macro environment: external, non-gaming context

Micro environment (optional): internal, in-game context (optional) (i.e., chat within the game that doesn't affect its outcome, etc.)

Micro environment (Required to play the game): social interaction needed in order to play the games (i.e., in-game cooperation or competition between players, etc.)

In some embodiments of the specifically programmed game database driven computer system of the present invention, a social element/creation of relationships with others variable can also be considered as having a situational aspect. In some embodiments, for instance, in sports betting the conversations within the premises with other players considering the game and its related sports activities are a facilitator for the creation of social relationships and thus it should be categorized as “Either macro or micro (optional),” as shown in Table 9.

TABLE 9
Scale

| None | Either | | | |
|---|---|---|---|---|
| (no macro or micro | macro | Only | Macro and | Both macro and |
| environment | or micro | micro | Micro | micro required or |
| social elements) | (optional) | (required) | (optional) | all three options |
| 0 | 2.5 | 5 | 7.5 | 10 |

In some embodiments of the specifically programmed game database driven computer system of the present invention, game speed is measured, as shown in Table 10. In some embodiments, the game speed indicates that the faster a game round is completed, the more addictive it tends to be. Although this concerns the speed of the round and not the frequency of rounds, it should be noted that games with frequencies of a day or more should be categorized as “Not Applicable” here regardless of the actual time it takes for the draw to complete. In some embodiments, for instance, a weekly lotto type game may have its drawing process completed within 5 minutes, but it still should be rated as “Not Applicable”.

TABLE 10
Scale

| Not | | >10 min ≦ | >3 min ≦ | >5 sec ≦ | |
|---|---|---|---|---|---|
| Applicable | >1 hrs | 1 hr | 10 min | 3 min | ≦5 sec |
| 0 | 0 | 2.5 | 5 | 7.5 | 10 |

Situational Characteristics: Offline Games: Macro-Environment

In some embodiments of the specifically programmed game database driven computer system of the present invention, the availability is measured, as shown in Table 11. In some embodiments, the availability is the possibility of accessing physical gambling opportunities. In some embodiments, availability refers to the density of point of sale (POS) at the implementation area.

TABLE 11
Scale

| Gambling | Gambling | Gambling | Gambling | Gambling | |
|---|---|---|---|---|---|
| opportunities | opportunities | opportunities | opportunities | opportunities | |
| within a | within a | within a | within a | within a | Gambling |
| radius | radius from >25 | radius from >10 | radius from >1 | radius | opportunities |
| of >100 km | km to ≦100 km | km to ≦25 km | km to ≦10 km | of ≦1 km | at home |
| 0 | 2.5 | 4 | 6 | 7.5 | 10 |

In some embodiments of the specifically programmed game database driven computer system of the present invention, gambling opportunities at home involve mail-in types of games, etc.

In some embodiments of the specifically programmed game database driven computer system of the present invention, there are payment options (cards, etc). In some embodiments, payment options (currency) are configured to ease the payment, as shown in Table 12. In another embodiment, the type of payment used to gamble is measured by the ease of use.

TABLE 12
Scale

| Cash only/Checks | Cash only with ATM on premises | Credit card |
|---|---|---|
| 0 | 5 | 10 |

In some embodiments of the specifically programmed game database driven computer system of the present invention, record setting/beating the game is measured, as shown in Table 13. In some embodiments, record setting/beating the game is when the player has the ability to set records or beat the game and if this fact is recorded and publicized, it is easier to be addicted in order to accomplish this feat and receive actual or perceived fame. In another embodiment, this is also true of large jackpots, global winning scoreboards, etc.

TABLE 13
Scale

| | Large jack-pots and/or | Large jack-pots and/or |
|---|---|---|
| | winning publicized | winning are widely |
| no record setting | (at venue level) | publicized |
| 0 | 5 | 10 |

Situational Characteristics: Offline Games: Micro-Environment

In some embodiments of the specifically programmed game database driven computer system of the present invention, game personalization is measured, as shown in Table 14. In some embodiments, game personalization is measured when the player has the ability to have a personalized version of the game and/or game preferences set/stored permanently and available when he plays (i.e., preferred color of chips, favorite number picks, etc.).

TABLE 14
Scale

| | Personalized version of the | Personalized version of the |
|---|---|---|
| | game or game preferences | game and game preferences |
| | set/stored permanently and | set/stored permanently and |
| Not applicable | available when he plays | available when he plays |
| 0 | 5 | 10 |

In some embodiments of the specifically programmed game database driven computer system of the present invention, aural and visual stimulation is measured, as shown in Table 15. In some embodiments, aural and visual stimulation is measured, wherein the flashier or more realistic presentations so as to attract more people and incline them to prolong their gaming and spending.

TABLE 15
Scale

| | Aural or visual | Aural and visual |
|---|---|---|
| Not applicable | stimulation | stimulation |
| 0 | 5 | 10 |

In some embodiments of the specifically programmed game database driven computer system of the present invention, free games/free game time is measured, as shown in Table 16. In some embodiments, free games/free game time is the ability to play games free of charge as part of a single promotion activity or a continuous activity.

TABLE 16
Scale

| | A single promotion | Continuous promotion |
|---|---|---|
| Not applicable | activity | activity |
| 0 | 5 | 10 |

Situational Characteristics: Online Games: Macro-Environment

In some embodiments of the specifically programmed game database driven computer system of the present invention, the availability/accessibility is measured, as shown in Table 17. In some embodiments, the availability/accessibility is the possibility of accessing virtual gambling opportunities.

TABLE 17
Scale

| Local machine | Local machine | | Online with | Online with |
|---|---|---|---|---|
| (online game) and | and unlimited | | mobile | dedicated mobile |
| limited game | game | | application for | application that |
| availability | availability | Online | results (i.e., iOS) | permits gambling |
| 0 | 2.5 | 5 | 7.5 | 10 |

In some embodiments of the specifically programmed game database driven computer system of the present invention, local machine and limited game availability is measured, which involves games like dog-race betting that are available online but only on premises and only at specific hours. In some embodiments, this parameter is related to the legal framework that each country/region practices, therefore, the same game can have different scores according to each implementation.

Situational Characteristics: Online Games: Micro-Environment

In some embodiments of the specifically programmed game database driven computer system of the present invention, payment options (cards, virtual currency, etc.) are currency, in which ease of pay is measured, as shown in Table 18. In some embodiments, payment options are the types of payments used to gamble and below shows a measurement for the ease of use.

TABLE 18
Scale

| | | Electronic payment |
|---|---|---|
| Wire transfer | Electronic payment | options and |
| only | options or virtual currency | virtual currency |
| 0 | 5 | 10 |

In some embodiments of the specifically programmed game database driven computer system of the present invention, electronic payment options include credit and debit cards, payment gateways (i.e., PayPal, etc.) etc.

In some embodiments of the specifically programmed game database driven computer system of the present invention, aural and visual stimulation is measured, as shown in Table 19. In some embodiments, aural and visual stimulation is measured, wherein flashier or more realistic presentations attract more people and incline them to prolong their gaming and spending.

TABLE 19
Scale

| | | Virtual reality |
|---|---|---|
| | Aural and visual | (i.e., player avatar in 3D |
| Not applicable | stimulation | environment) |
| 0 | 5 | 10 |

In some embodiments of the specifically programmed game database driven computer system of the present invention, the presence of free practice games is measured, as shown in Table 20. In some embodiments, the presence of free practice games is measured while entering the game. In some embodiments, this measurement comprises the ability to play games free of charge as part of game promotion with the same or different odds as the actual game.

TABLE 20
Scale

| | Free practice games | Free practice games |
|---|---|---|
| | with the same odds as the | with different odds than the |
| Not applicable | actual game | actual game |
| 0 | 5 | 10 |

In some embodiments of the specifically programmed game database driven computer system of the present invention, a game can be personalized. In some embodiments, game personalization is when a player has the ability to have a personalized version of the game or a permanent user personalization via loyalty schemes, tracking, login, etc., as shown in Table 21.

TABLE 21
Scale

| | | Permanent user |
|---|---|---|
| | | personalization via loyalty |
| Not applicable | User personalization | schemes, tracking, login etc. |
| 0 | 5 | 10 |

In some embodiments of the specifically programmed game database driven computer system of the present invention, a measurement is record setting/beating the game. In some embodiments, record setting/beating the game is when the player has the ability to set records or beat the game and if this fact is recorded and publicized, it is easier to be addicted in order to accomplish this feat and receive actual or perceived fame, as shown in Table 22. In some embodiments, this is true of large jackpots, global winning scoreboards, etc.

TABLE 22
Scale

| | | Large jack-pots | | Member |
|---|---|---|---|---|
| | Large jack-pots and/or | and/or winning | | of a |
| | winning widely | widely publicized in | | special |
| no record | publicized in | a permanent | User | user- |
| setting | temporary scoreboard | scoreboard | badge | group |
| 0 | 2.5 | 5 | 7.5 | 10 |

Responsible Gaming Characteristics: Offline Games

In some embodiments of the specifically programmed game database driven computer system of the present invention, player initiated spending, loss or deposit limits are measured, as shown in Table 23. In some embodiments, users are able to define how much they would like to spend, deposit, or lose in a specified time period. In some embodiments, these limits can either be temporary or permanent.

TABLE 23
Scale

| | | | Temporary, | |
|---|---|---|---|---|
| | | Temporary, “hard” | “soft”user- | |
| | | user-specified | specified limits | |
| | | limits (i.e., user | (i.e., user can | |
| Permanent, | Permanent, | cannot reset the | reset the | |
| company | user- | limits during the | limits during | |
| specified | specified | specified time | the specified | No |
| limits | limits | period) | time period) | limits |
| 0 | 2.5 | 5 | 7.5 | 10 |

In some embodiments of the specifically programmed game database driven computer system of the present invention, user-specified time limits are measured. In some embodiments, player initiated time limits that can either be “hard” (i.e., once set, the limit cannot be reset by the user) or “soft” (i.e., once set, the limit can be reset by the user) that are valid for a pre-specified period of time, as shown in Table 24. In some embodiments, games with frequencies of a day or more, e.g. lotteries, lotto, etc., are rated as “not applicable” in this embodiment.

TABLE 24
Scale

| | “Hard” player | | |
|---|---|---|---|
| | initiated time limits | “Soft” player initiated | |
| | (i.e., once set, the | time limits (i.e., once | |
| Not | limit cannot be reset | set, the limit can be | |
| Applicable | by the user) | reset by the user) | Not available |
| 0 | 0 | 5 | 10 |

In some embodiments of the specifically programmed game database driven computer system of the present invention, customer tracking and support for problematic gambling behavior (responsible gaming) is evaluated, as shown in Table 25. In some embodiments, the evaluation is based on whether continuous player behavioral feedback and warning of changes in behavior, and/or support are offered by trained staff. In some embodiments, training POS personnel to observe, track and advise players for problematic gambling behavior and offer pointers for further help, is considered adequate for a “0” score in this question.

TABLE 25
Scale

| Offering continuous player behavioral | |
|---|---|
| feedback, warning of changes in | |
| behavior and/or support | Not available |
| 0 | 10 |

In some embodiments of the specifically programmed game database driven computer system of the present invention, player initiated self-exclusion is measured, as shown in Table 26. In some embodiments, the player initiated self-exclusion is temporary or permanent. In some embodiments, players have the option to define how much they would like to spend, deposit, or lose in a specified time period. In some embodiments, these limits can be either temporary or permanent. In some embodiments, trained personnel that impose informal player initiated self-exclusion and direction to further help for problematic gamblers are considered in the same grade as “temporary only”.

TABLE 26
Scale

| | Temporary player initiated | |
|---|---|---|
| | self-exclusion or | |
| Permanent player | Informal player initiated self- | |
| initiated self- | exclusion by trained | |
| exclusion | personnel (Temporary Only) | Not available |
| 0 | 5 | 10 |

In some embodiments of the specifically programmed game database driven computer system of the present invention, physical responsible gaming signage is evaluated. In some embodiments, the existence of signs, providing information about problem gambling support services is measured, as shown in Table 27.

TABLE 27
Scale

| Physical responsible gaming signs, | |
|---|---|
| providing information about problem | |
| gambling support services | Not available |
| 0 | 10 |

In some embodiments of the specifically programmed game database driven computer system of the present invention, providing a voluntary diagnostic self-test to help players better understand their gambling behavior is measured, as shown in Table 28.

TABLE 28
Scale

| Providing a voluntary diagnostic self- | |
|---|---|
| test to help players better understand | |
| their gambling behavior | Not available |
| 0 | 10 |

Responsible Gaming Characteristics: Online Games

In some embodiments of the specifically programmed game database driven computer system of the present invention, player initiated spending, loss or deposit limits is measured, as shown in Table 29. In some embodiments of the specifically programmed game database driven computer system of the present invention, users are able to define how much they would like to spend, deposit, or lose in a specified time period. In some embodiments, these limits can be either temporary or permanent.

TABLE 29
Scale

| | | Temporary, “hard” | Temporary, “soft” | |
|---|---|---|---|---|
| | | user-specified | user-specified | |
| | | limits (i.e., user | limits (i.e., user | |
| Permanent, | | cannot reset the | can reset the | |
| company | Permanent, | limits during the | limits during the | |
| specified | user-specified | specified time | specified time | |
| limits | limits | period) | period) | No limits |
| 0 | 2.5 | 5 | 7.5 | 10 |

In some embodiments of the specifically programmed game database driven computer system of the present invention, user-specified time limits are measured. In some embodiments, player initiated time limits can be either “hard” (i.e., once set, the limit cannot be reset by the user) or “soft” (i.e., once set, the limit can be reset by the user) and are valid for a pre-specified period of time, as shown in Table 30.

TABLE 30
Scale

| “Hard” player initiated time | “Soft” player initiated time | |
|---|---|---|
| limits (i.e., once set, the | limits (i.e., once set, the | |
| limit cannot be reset by the | limit can be reset by the | |
| user) or not applicable | user) | Not available |
| 0 | 5 | 10 |

In some embodiments of the specifically programmed game database driven computer system of the present invention, online customer tracking and support for problematic gambling behavior (Responsible gaming) is measured. In some embodiments, offering continuous online player behavioral feedback and warning of changes in behavior, and/or support are measured, as shown in Table 31.

TABLE 31
Scale

| Offering continuous online player | |
|---|---|
| behavioral feedback, warning of changes | |
| in behavior and/or support | Not available |
| 0 | 10 |

In some embodiments of the specifically programmed game database driven computer system of the present invention, player initiated self-exclusion (i.e., temporary, permanent) is measured. In some embodiments, players have the option to define how much they would like to spend, deposit, or lose in a specified time period. In some embodiments, these limits can be either temporary or permanent, as shown in Table 32.

TABLE 32
Scale

| Permanent player initiated | Temporary player initiated | |
|---|---|---|
| self-exclusion | self-exclusion | Not available |
| 0 | 5 | 10 |

In some embodiments of the specifically programmed game database driven computer system of the present invention, use of pop-up warnings is measured. In some embodiments, use of pop-up warnings to alert the user for the time played, amount lost, etc. is evaluated, as shown in Table 33.

TABLE 33
Scale

| Use of pop-up warnings to alert the user | |
|---|---|
| for the time played, amount lost etc. | Not available |
| 0 | 10 |

In some embodiments of the specifically programmed game database driven computer system of the present invention, providing a voluntary diagnostic self-test to help players better understand their gambling behavior is measured, as shown in Table 34.

TABLE 34
Scale

| Providing a voluntary diagnostic self- | |
|---|---|
| test to help players better understand | |
| their gambling behavior | Not available |
| 0 | 10 |

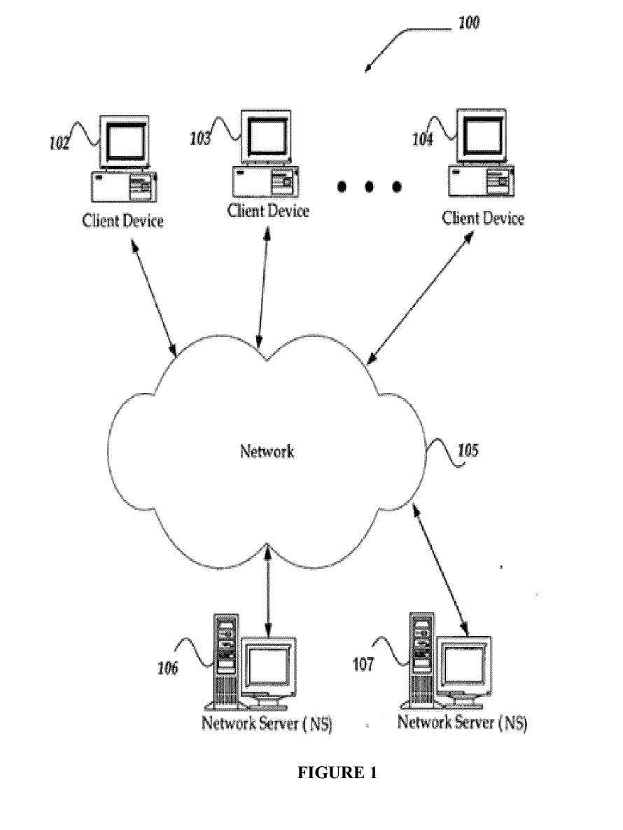

FIG. 1 illustrates an embodiment of the specifically programmed game database driven computer method of the present invention.

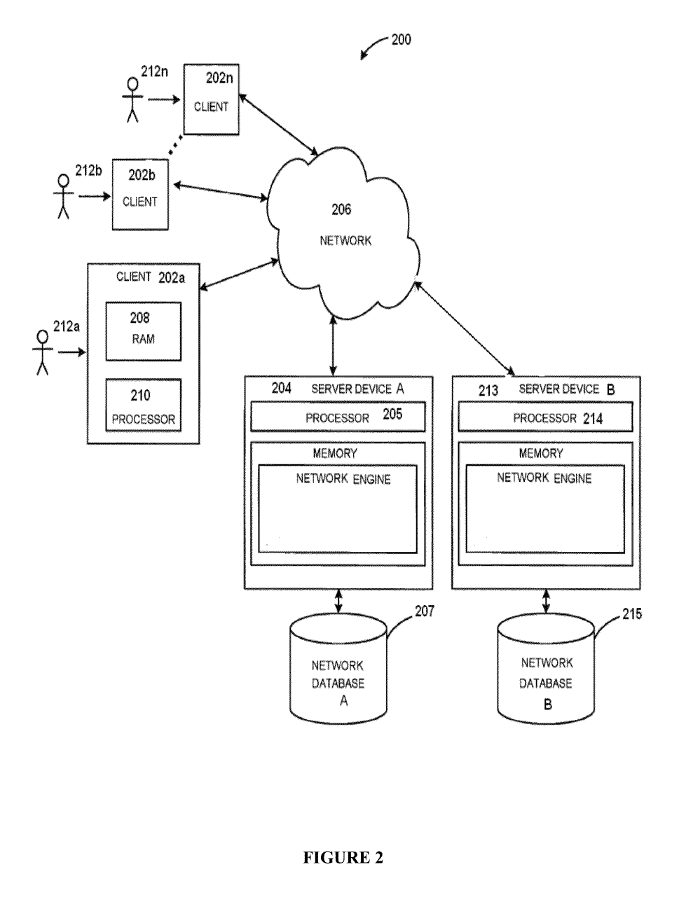

FIG. 2 illustrates an embodiment of the network architecture of the specifically programmed game database driven computer method of the present invention.

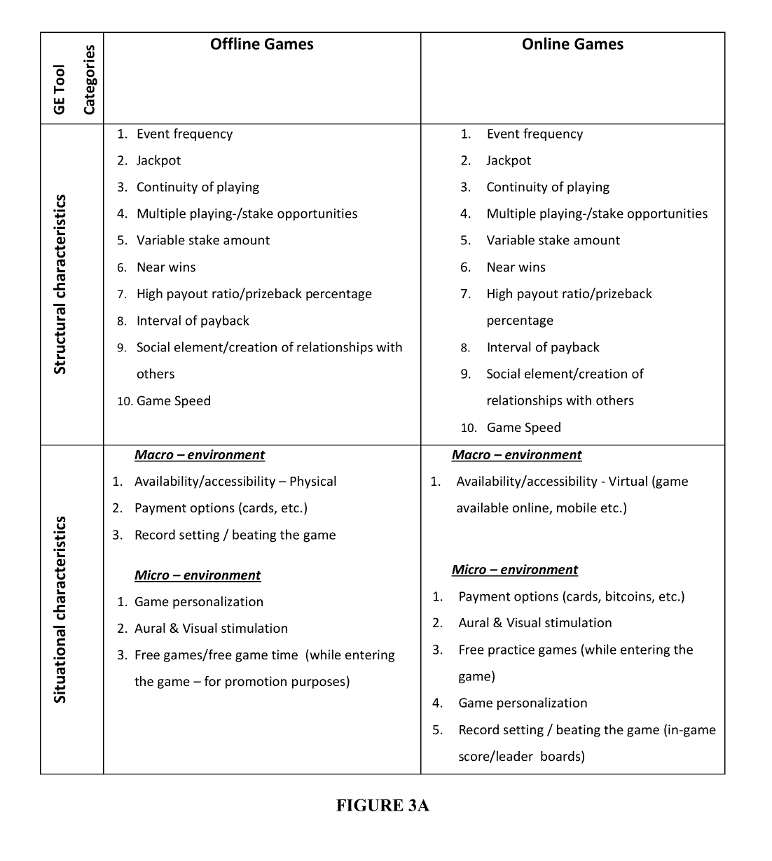

FIGS. 3A and 3B illustrate embodiments of the com specifically programmed game database driven computer method of the present invention, FIGS. 3A and 3B present an overview of the invention, its categories and subcategories as well as the characteristics.

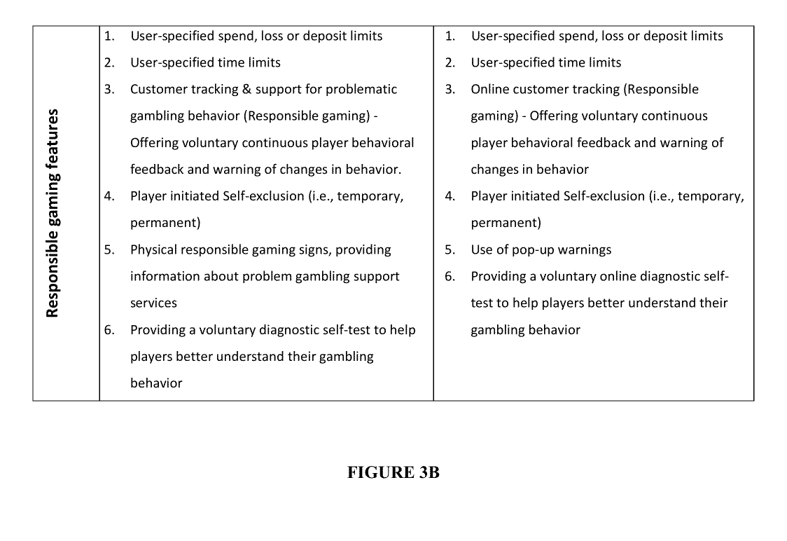

FIG. 4 illustrates an embodiment of the specifically programmed game database driven computer method of the present invention, showing an analysis of Game Risk Assessment Instruments. In some embodiments, the present invention is a tool that integrates a wide set of variables and takes into consideration the “implementation context” and the different “game modes” (i.e., online, offline games). In some embodiments, the present invention integrates two distinct assessment instruments: one instrument for the offline games, and one instrument for the online games. In some embodiments, low diagnostic severity is measured as a calculation between 0.67 and 1.0. In some embodiments, medium diagnostic severity is measured as a calculation between 0.33 and 0.67. In some embodiments, high diagnostic severity is measured as a calculation between 0.00 and 0.33.

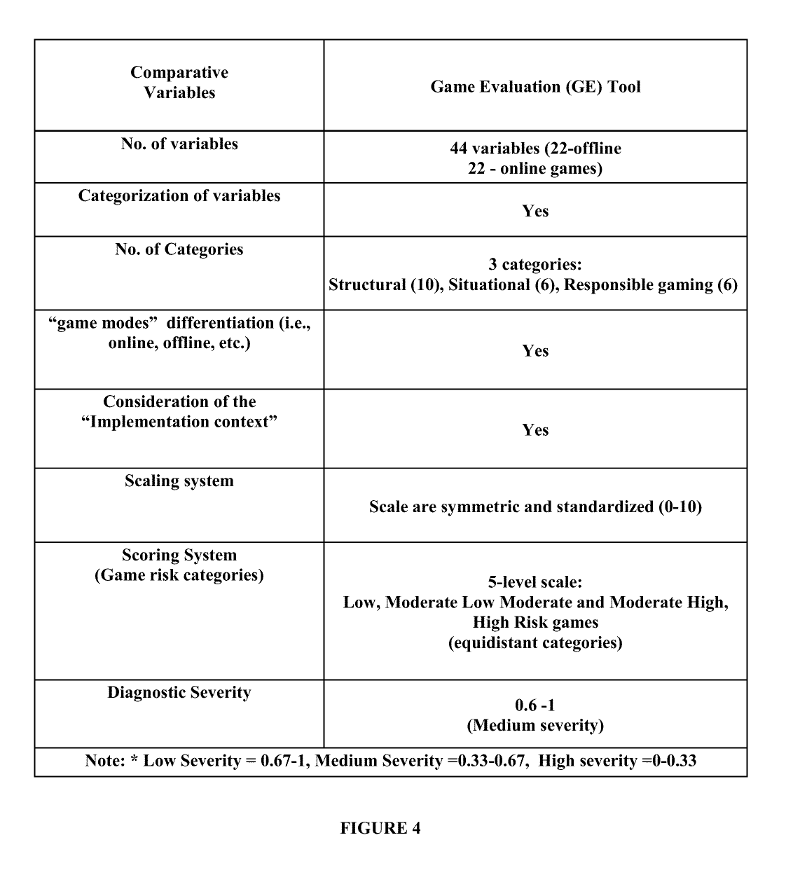

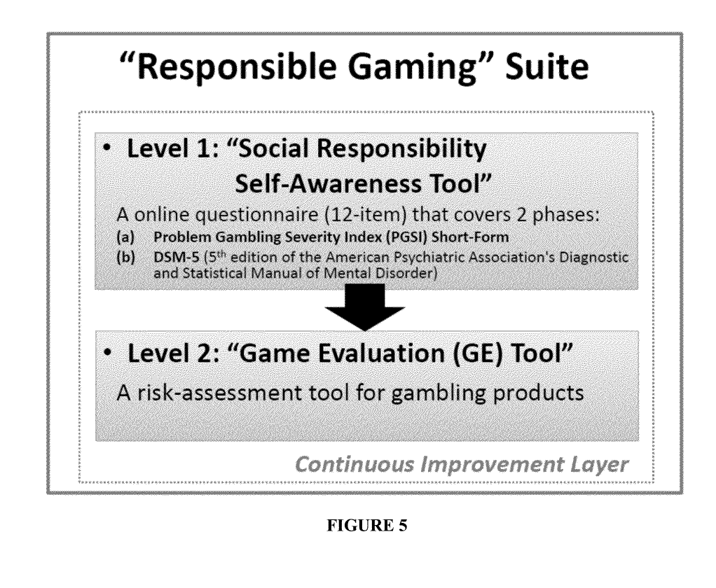

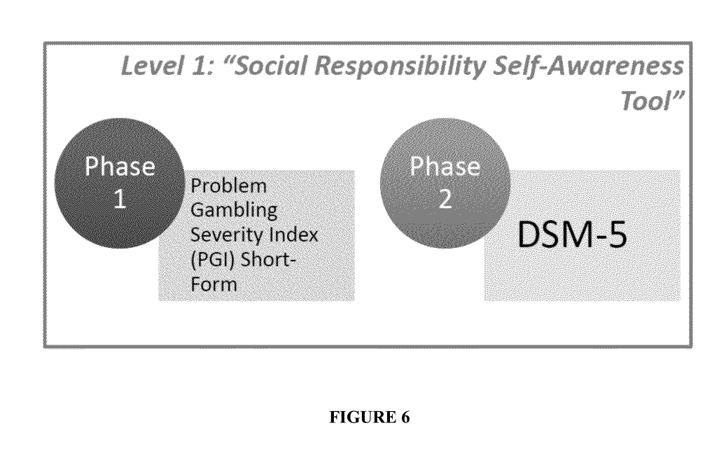

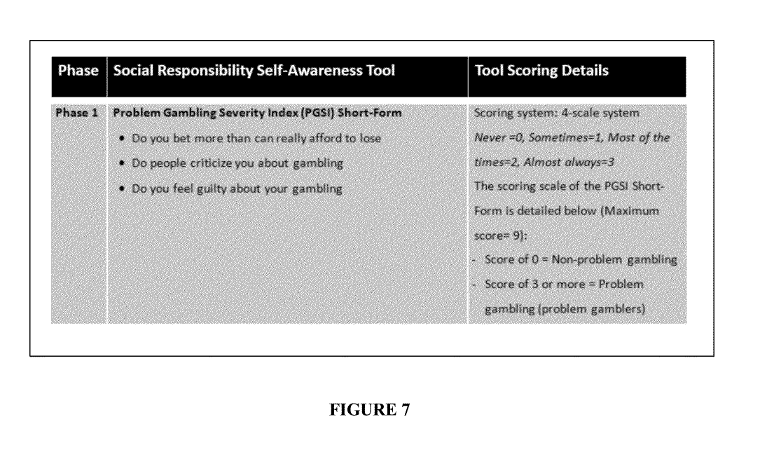

FIGS. 5-8 are illustrative diagrams related to some embodiments of the specifically programmed game database driven computer method of the present invention. The specific disclosure of American Psychiatric Association's Diagnostic and Statistical Manual of Mental Disorder (Fifth Edition, 2013) is hereby incorporated by reference herein in its entirety.

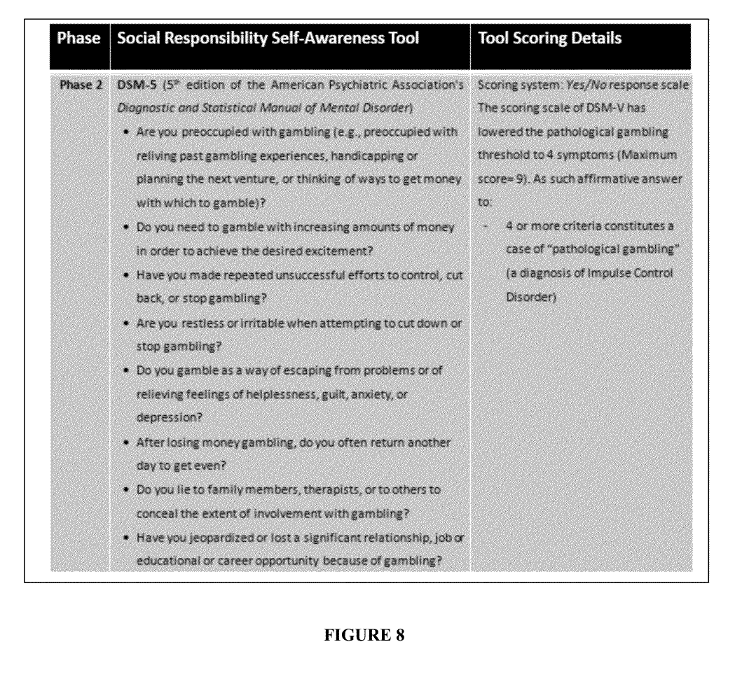

FIG. 9 is an illustrative diagram related to some embodiments of the specifically programmed game database driven computer methods of the present invention.

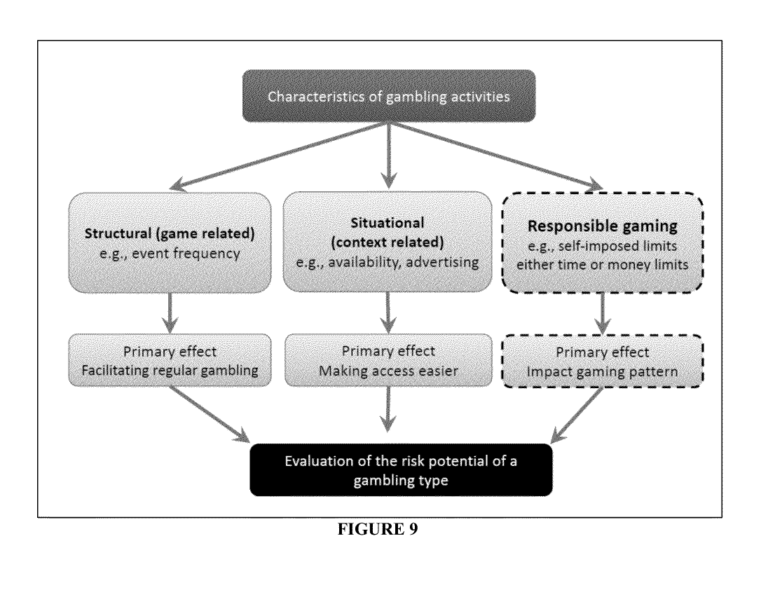

FIG. 10 is an illustrative diagram related to some embodiments of the specifically programmed game database driven computer method of the present invention. In some embodiments, the scoring system is a five level risk scale and the categories are equidistant.

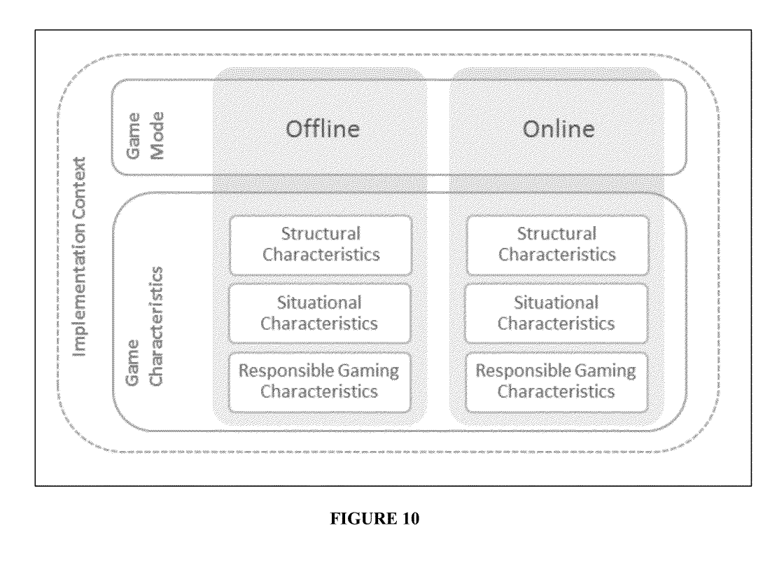

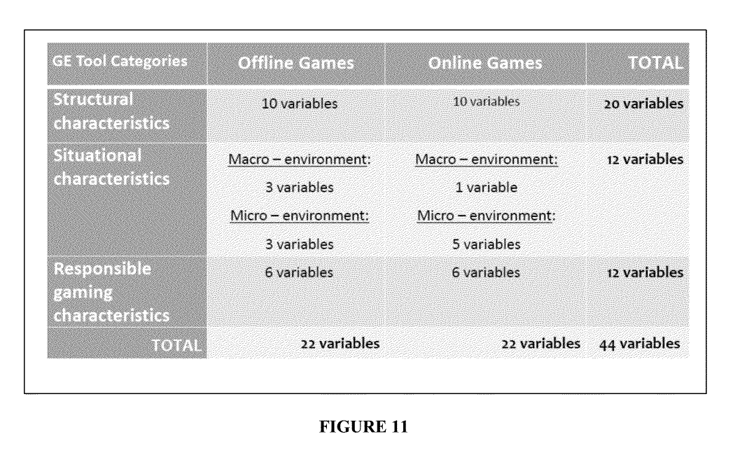

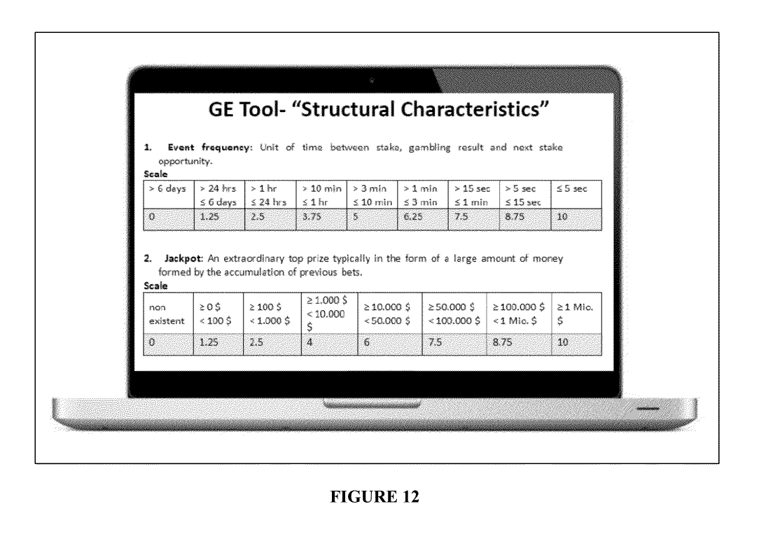

FIGS. 11-13 are illustrative diagrams related to some embodiments of the specifically programmed game database driven computer method of the present invention. In some embodiments, different games with “known” risk levels were scored and compared. In some embodiments, the scales are symmetric and standardized between 0-10 (0=of no importance and 10=of great importance).

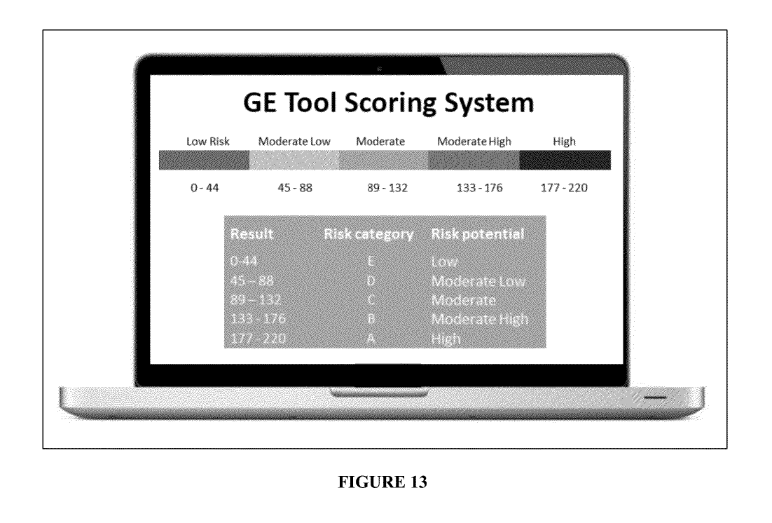

FIG. 14 is an illustrative diagram related to some embodiments of the specifically programmed game database driven computer method of the present invention. In some embodiments, different games with “known” risk levels were scored and compared.

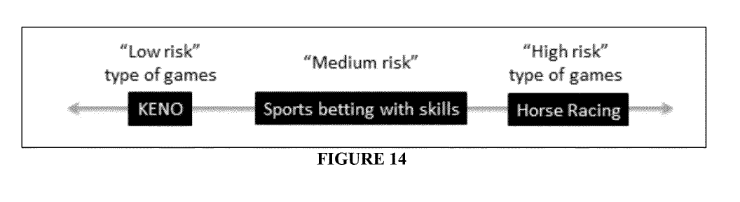

FIG. 15 is an illustrative diagram related to some embodiments of the specifically programmed game database driven computer methods of the present invention.

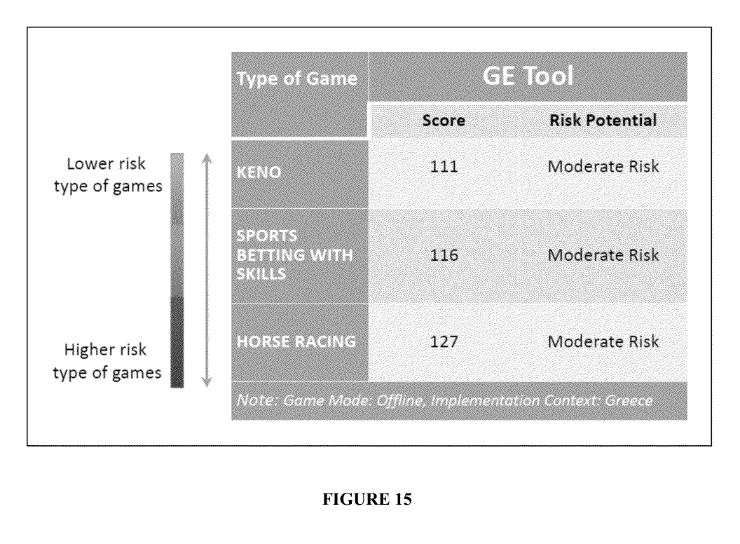

FIG. 16 is an illustrative diagram related to some embodiments of the specifically programmed game database driven computer methods of the present invention.

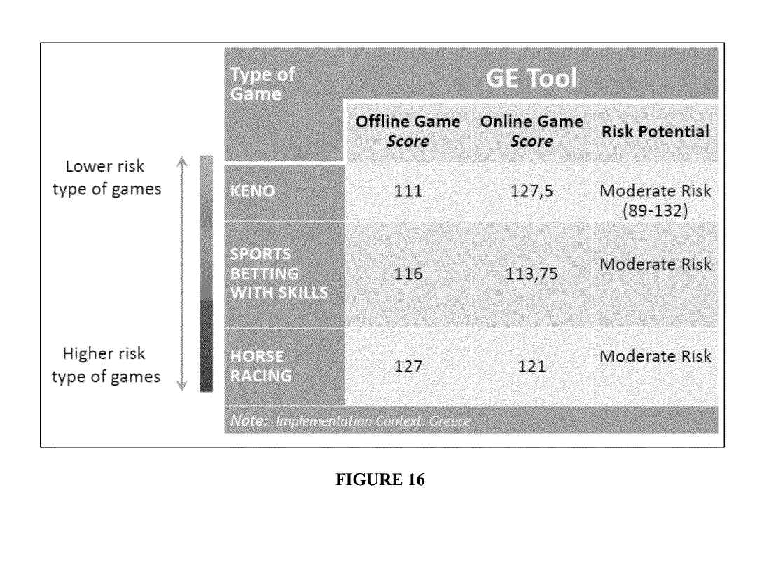

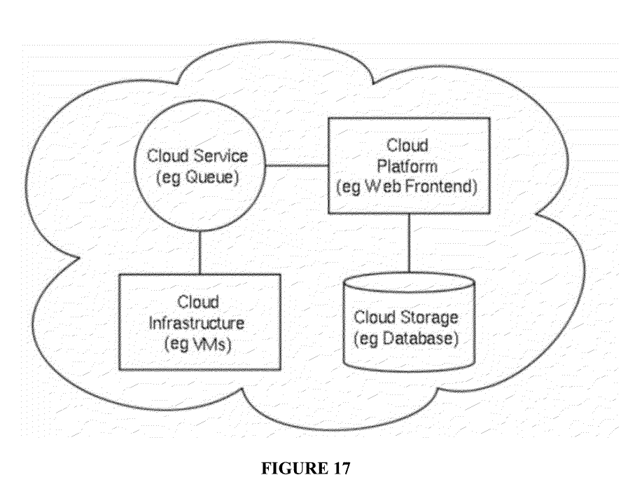

FIGS. 17 and 18 illustrate some further aspects of some embodiments of the specifically programmed game database driven computer methods of the present invention.

FIGS. 19 and 20 illustrate some further aspects of some embodiments of the specifically programmed game database driven computer methods of the present invention.

Illustrative Operating Environments

FIG. 1 illustrates one embodiment of an environment in which the present invention may operate. However, not all of these components may be required to practice the invention, and variations in the arrangement and type of the components may be made without departing from the spirit or scope of the present invention. In some embodiments, the system and method may include a large number (e.g., at least 1,000; at least 10,000; at least 100,000; at least 1,000,000) of players and/or playing devices/terminals (e.g., lottery terminals, casino terminals, personal computing devices such as laptops, smartphones, etc.) and/or concurrent transactions (e.g., at least 1,000; at least 10,000; at least 100,000; at least 1,000,000). In other embodiments, the system and method are based on a scalable computer and network architecture that incorporates varies strategies for assessing the data, caching, searching, and database connection pooling. An example of the scalable architecture is an architecture that is capable of operating multiple servers. In an embodiment, one or more clients can be a mobile client.

In embodiments, members of the computer system 102-104 include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In embodiments, programming may include either Java, .Net, QT, C, C++ or other suitable programming language.

In embodiments, member devices 102-104 may be further configured to receive a message from another computing device employing another mechanism, including, but not limited to email, Short Message Service (SMS), Multimedia Message Service (MMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

FIG. 2 shows another exemplary embodiment of the computer and network architecture that supports the method and system. The member devices 202a, 202b thru 202n shown each at least includes a computer-readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a may be any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera. Through the client devices 202a-n, users, 212a-n communicate over the network 206 with each other and with other systems and devices coupled to the network 206. As shown in FIG. 1B, server devices 204 and 213 may be also coupled to the network 206. In an embodiment, one or more clients can be a mobile client.

In some embodiments, the term “mobile electronic device” may refer to any portable electronic device that may or may not be enabled with location tracking functionality. For example, a mobile electronic device can include, but is not limited to, a mobile phone, Personal Digital Assistant (PDA), Blackberry™, Pager, Smartphone, or any other reasonable mobile electronic device. For ease, at times the above variations are not listed or are only partially listed, this is in no way meant to be a limitation.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, near-field wireless communication (NFC) can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less.

In some embodiments, NFC may operate at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable devices within close proximity of each other.

For purposes of the instant description, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). In some embodiments, the instant invention offers/manages the cloud computing/architecture as, but not limiting to: infrastructure a service (IaaS), platform as a service (PaaS), and software as a service (SaaS). FIGS. 17 and 18 illustrate schematics of exemplary implementations of the cloud computing/architecture.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

In some embodiments, the instant invention provides for a computer-implemented method, including: concurrently receiving, via a computer network, by a specifically programmed game operating system, from each user of the plurality of users, utilizing a specialized graphical user interface generated by user risk evaluation software distributed by the specifically programmed game operating system to a computer device of such user, responses to at least one social responsibility self-awareness test; where the plurality of users is at least a thousand of users; where the at least one social responsibility self-awareness test includes a plurality of questions related to psychiatric characteristics of a gambling addiction; concurrently analyzing, by the specifically programmed game operating system, for each user of the plurality of users, the responses of such user to the at least one social responsibility self-awareness test to determine a gambling self-awareness score of such user, based, at least in part, on a problem gambling severity index (PGSI); concurrently identifying, by the specifically programmed game operating system, for each user of the plurality of users, at least one game that such user is playing or is to be played; where the at least one game is characterized by at least one structural characteristic of a plurality of structural characteristics and at least one situational characteristic of a plurality of situational characteristics; where the plurality of the structural characteristics is selected from the group consisting of: event frequency, jackpot, continuity of playing, multiple playing/stake opportunities, variable stake amount, near wins, high payout ratio/prizeback percentage, interval of payback, social element/creation of relationships with others, game speed, and any combination thereof; concurrently analyzing, by the specifically programmed game operating system, for each user of the plurality of users, the at least one game to determine a personalized addictiveness value of the at least one game for such user, based, at least in part, on: i) the gambling self-awareness score of such user, ii) the at least one structural characteristic of the at least one game, and iii) the at least one situational characteristic of the at least one game; concurrently generating, by the specifically programmed game operating system, for each user of the plurality of users, at least one personalized game addictiveness alert for such user, based on the personalized addictiveness value of the at least one game for such user; concurrently delivering, via the computer network, by the specifically programmed game operating system, to each user of the plurality of users, utilizing the specialized graphical user interface generated by the user risk evaluation software distributed by the specifically programmed game operating system to the computer device of such user, the at least one personalized game addictiveness alert.

In some embodiments, the personalized game addictiveness alert is configured to allow each user of the plurality of users to set at least one risk averse parameter in the at least one game, wherein the at least one risk averse parameter is selected from the group consisting of: (a) user-specified spend limits, (b) user-specified loss limits, (c) user-specified deposit limits, (d) user-specified time limits, (e) user-initiated self-exclusion, or (f) any combination thereof. In some embodiments, the method further includes incorporating, by the specifically programmed game operating system, the at least one risk averse parameter into the at least one game. In some embodiments, situational characteristics include: game personalization, aural stimulation and visual stimulation, free games, or any combination thereof. In some embodiments, the situational characteristics of an offline game includes: physical availability/accessibility, payment options, record setting/beating the game, or any combination thereof. In some embodiments, the situational characteristics of an online game includes: virtual availability/accessibility, payment options, record setting/beating the game, or any combination thereof.

In some embodiments, the instant invention provides for a computer-implemented system, including: at least one specialized server specifically programmed with game evaluation software stored on a non-transient computer readable medium, where the specialized server, upon execution of the specifically programmed with game evaluation software is configured to at least perform: concurrently receive, via a computer network, from each user of the plurality of users, utilizing a specialized graphical user interface generated by user risk evaluation software distributed by the specifically programmed game operating system to a computer device of such user, responses to at least one social responsibility self-awareness test; where the plurality of users is at least a thousand of users; where the at least one social responsibility self-awareness test includes a plurality of questions related to psychiatric characteristics of a gambling addiction; concurrently analyze, for each user of the plurality of users, the responses of such user to the at least one social responsibility self-awareness test to determine a gambling self-awareness score of such user, based, at least in part, on a problem gambling severity index (PGSI); concurrently identify, for each user of the plurality of users, at least one game that such user is playing or is to be played; where the at least one game is characterized by at least one structural characteristic of a plurality of structural characteristics and at least one situational characteristic of a plurality of situational characteristics; where the plurality of the structural characteristics is selected from the group consisting of: event frequency, jackpot, continuity of playing, stake opportunities, variable stake amount, near wins, prizeback percentage, interval of payback, social element, game speed, and any combination thereof; concurrently analyze, for each user of the plurality of users, the at least one game to determine a personalized addictiveness value of the at least one game for such user, based, at least in part, on: i) the gambling self-awareness score of such user, ii) the at least one structural characteristic of the at least one game, and iii) the at least one situational characteristic of the at least one game; concurrently generate, for each user of the plurality of users, at least one personalized game addictiveness alert for such user, based on the personalized addictiveness value of the at least one game for such user; concurrently deliver, via the computer network, to each user of the plurality of users, utilizing the specialized graphical user interface generated by the user risk evaluation software distributed by the specifically programmed game operating system to the computer device of such user, the at least one personalized game addictiveness alert.

In some embodiments, the personalized game addictiveness alert is configured to allow each user of the plurality of users to set at least one risk averse parameter in the at least one game, where the at least one risk averse parameter is selected from the group consisting of: (a) user-specified spend limits, (b) user-specified loss limits, (c) user-specified deposit limits, (d) user-specified time limits, (e) user-initiated self-exclusion, or (f) any combination thereof. In some embodiments, the system further includes incorporating, by the specifically programmed game operating system, the at least one risk averse parameter into the at least one game. In some embodiments, the situational characteristics include: game personalization, aural stimulation and visual stimulation, free games, or any combination thereof. In some embodiments, the situational characteristics of an offline game includes: physical accessibility, payment options, record setting, or any combination thereof. In some embodiments, the situational characteristics of an online game includes: virtual accessibility, payment options, record setting, or any combination thereof.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A computer-implemented method, comprising:
concurrently receiving, via a computer network, by a specifically programmed game operating system, from each user of the plurality of users, utilizing a specialized graphical user interface generated by user risk evaluation software distributed by the specifically programmed game operating system to a computer device of such user, responses to at least one social responsibility self-awareness test;
wherein the plurality of users is at least a thousand of users;
wherein the at least one social responsibility self-awareness test comprises a plurality of questions related to psychiatric characteristics of a gambling addiction;
concurrently analyzing, by the specifically programmed game operating system, for each user of the plurality of users, the responses of such user to the at least one social responsibility self-awareness test to determine a gambling self-awareness score of such user, based, at least in part, on a problem gambling severity index (PGSI);
concurrently identifying, by the specifically programmed game operating system, for each user of the plurality of users, at least one game that such user is playing or is to be played;
wherein the at least one game is characterized by at least one structural characteristic of a plurality of structural characteristics and at least one situational characteristic of a plurality of situational characteristics;
wherein the plurality of the structural characteristics is selected from the group consisting of: event frequency, jackpot, continuity of playing, multiple stake opportunities, variable stake amount, near wins, prizeback percentage, interval of payback, social element, game speed, and any combination thereof;
concurrently analyzing, by the specifically programmed game operating system, for each user of the plurality of users, the at least one game to determine a personalized addictiveness value of the at least one game for such user, based, at least in part, on:
i) the gambling self-awareness score of such user,
ii) the at least one structural characteristic of the at least one game, and
iii) the at least one situational characteristic of the at least one game;
concurrently generating, by the specifically programmed game operating system, for each user of the plurality of users, at least one personalized game addictiveness alert for such user, based on the personalized addictiveness value of the at least one game for such user;
concurrently delivering, via the computer network, by the specifically programmed game operating system, to each user of the plurality of users, utilizing the specialized graphical user interface generated by the user risk evaluation software distributed by the specifically programmed game operating system to the computer device of such user, the at least one personalized game addictiveness alert.

2. The computer-implemented method of claim 1, wherein the personalized game addictiveness alert is configured to allow each user of the plurality of users to set at least one risk averse parameter in the at least one game, wherein the at least one risk averse parameter is selected from the group consisting of: (a) user-specified spend limits, (b) user-specified loss limits, (c) user-specified deposit limits, (d) user-specified time limits, (e) user-initiated self-exclusion, or (f) any combination thereof.

3. The computer-implemented method of claim 1, further comprising incorporating, by the specifically programmed game operating system, the at least one risk averse parameter into the at least one game.

4. The computer-implemented method of claim 1, wherein the situational characteristics comprise: game personalization, aural stimulation and visual stimulation, free games, or any combination thereof.

5. The computer-implemented method of claim 1, wherein the situational characteristics of an offline game comprises: physical accessibility, payment options, record setting, or any combination thereof.

6. The computer-implemented method of claim 1, wherein the situational characteristics of an online game comprises: virtual accessibility, payment options, record setting, or any combination thereof.

7. A computer-implemented system, comprising:
at least one specialized server specifically programmed with game evaluation software stored on a non-transient computer readable medium,
wherein the specialized server, upon execution of the specifically programmed with game evaluation software is configured to at least perform:
concurrently receive, via a computer network, from each user of the plurality of users, utilizing a specialized graphical user interface generated by user risk evaluation software distributed by the specifically programmed game operating system to a computer device of such user, responses to at least one social responsibility self-awareness test;
wherein the plurality of users is at least a thousand of users;
wherein the at least one social responsibility self-awareness test comprises a plurality of questions related to psychiatric characteristics of a gambling addiction;
concurrently analyze, for each user of the plurality of users, the responses of such user to the at least one social responsibility self-awareness test to determine a gambling self-awareness score of such user, based, at least in part, on a problem gambling severity index (PGSI);
concurrently identify, for each user of the plurality of users, at least one game that such user is playing or is to be played;
wherein the at least one game is characterized by at least one structural characteristic of a plurality of structural characteristics and at least one situational characteristic of a plurality of situational characteristics;
wherein the plurality of the structural characteristics is selected from the group consisting of: event frequency, jackpot, continuity of playing, stake opportunities, variable stake amount, near wins, prizeback percentage, interval of payback, social element, game speed, and any combination thereof;
concurrently analyze, for each user of the plurality of users, the at least one game to determine a personalized addictiveness value of the at least one game for such user, based, at least in part, on:
i) the gambling self-awareness score of such user,
ii) the at least one structural characteristic of the at least one game, and
iii) the at least one situational characteristic of the at least one game;
concurrently generate, for each user of the plurality of users, at least one personalized game addictiveness alert for such user, based on the personalized addictiveness value of the at least one game for such user;
concurrently deliver, via the computer network, to each user of the plurality of users, utilizing the specialized graphical user interface generated by the user risk evaluation software distributed by the specifically programmed game operating system to the computer device of such user, the at least one personalized game addictiveness alert.

8. The computer-implemented system of claim 7, wherein the personalized game addictiveness alert is configured to allow each user of the plurality of users to set at least one risk averse parameter in the at least one game, wherein the at least one risk averse parameter is selected from the group consisting of: (a) user-specified spend limits, (b) user-specified loss limits, (c) user-specified deposit limits, (d) user-specified time limits, (e) user-initiated self-exclusion, or (f) any combination thereof.

9. The computer-implemented system of claim 7, further comprising incorporating, by the specifically programmed game operating system, the at least one risk averse parameter into the at least one game.

10. The computer-implemented system of claim 7, wherein the situational characteristics comprise: game personalization, aural stimulation and visual stimulation, free games, or any combination thereof.

11. The computer-implemented system of claim 7, wherein the situational characteristics of an offline game comprises: physical accessibility, payment options, record setting, or any combination thereof.

12. The computer-implemented system of claim 7, wherein the situational characteristics of an online game comprises: virtual accessibility, payment options, record setting, or any combination thereof.
